(19) United States
(12) Patent Application Publication
(10) Pub. No.: US 2024/0306094 A1
(43) Pub. Date: Sep. 12, 2024

(54) REALIZING GAINS FOR HIGH-EFFICIENCY (HE) EXTENDED RANGE (ER) WITH OR WITHOUT DUAL CARRIER MODULATION (DCM) MODES

(71) Applicant: QUALCOMM Incorporated, San Diego, CA (US)

(72) Inventors: Akansh JAIN, Chennai (IN); Vinod BELUR RAMACHANDRA, Chennai (IN); Sarath Kumar MAHENDRADA, Kakinada (IN); Arul Durai Murugan PALANIVELU, Bangalore (IN); Suresh CHANDRASEKARAN, Kanchipuram (IN); Sriram PARTHASARATHY, Chennai (IN)

(21) Appl. No.: 18/179,935

(22) Filed: Mar. 7, 2023

(51) Int. Cl. H04W 52/18

(52) U.S. Cl. CPC H04W 52/18

(57) ABSTRACT

This disclosure provides methods and devices for realizing sensitivity gains for high-efficiency (HE) extended range (ER) dual carrier modulation (DCM) modes. A wireless communication device can determine one or more preamble symbols of a packet based on a mode of transmission of the packet, the one or more preamble symbols of the packet being associated with a receiver sensitivity limitation. The wireless communication device can apply a power boost of a to the one or more preamble symbols by a power boost value, the power boost value being based on the mode of transmission of the packet. The wireless communication device can determine whether the one or more preamble symbols with the applied power boost satisfy a spectral mask. The wireless communication device can transmit the packet when the one or more preamble symbols with the applied power boost satisfy the spectral mask.

### TECHNICAL FIELD

This disclosure relates generally to wireless communication, and more specifically, to realizing gains for high-efficiency (HE) extended range (ER) dual carrier modulation (DCM) modes.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In WLAN, backscattering-based devices use reflection to communicate, rather than transmitting their own signals. This can be an attractive solution for low-power and low-data rate applications, such as those found in the Internet-of-Things (IoT). Backscattering-based devices may operate in unlicensed spectrums, such as the 2.4 GHz and 5 GHz bands. These devices can modulate the reflected signal and transmit data. Integration of backscattering-based devices into existing wireless networks poses a challenge to enable these devices to effectively communicate with normal devices that are not designed to detect reflected signals.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. In some implementations, the wireless communication device may include at least one memory; and at least one processor communicatively coupled with the at least one memory, the at least one processor operable to cause the wireless communication device to: determine one or more preamble symbols of a packet based on a mode of transmission of the packet, the one or more preamble symbols of the packet being associated with a receiver sensitivity limitation; apply a power boost to the one or more preamble symbols by a power boost value, the power boost value being based on the mode of transmission of the packet; determine whether the one or more preamble symbols with the applied power boost satisfy a spectral mask; and transmit the packet when the one or more preamble symbols with the applied power boost satisfy the spectral mask.

Another innovative aspect of the subject matter described in this disclosure can be implemented in a method of wireless communication. The method may be performed by a STA, and may include determining one or more preamble symbols of a packet based on a mode of transmission of the packet, the one or more preamble symbols of the packet being associated with a receiver sensitivity limitation; applying a power boost of a to the one or more preamble symbols by a power boost value, the power boost value based on the mode of transmission of the packet; determining whether the one or more preamble symbols with the applied power boost satisfy a spectral mask; and transmitting the packet when the one or more preamble symbols with the applied power boost satisfy the spectral mask.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram of an example wireless communication device.

FIG. 3A shows a block diagram of an example access point (AP).

FIG. 3B shows a block diagram of an example station (STA).

FIG. 4 shows a pictorial diagram of another example wireless communication network 400.

FIG. 5 illustrates a simplified block diagram of a destination device communicating with a source device in a wireless communications system.

FIG. 6 shows another example PPDU 650 usable for wireless communication between a wireless AP and one or more wireless STAs.

FIG. 7 shows different example PPDUs usable for wireless communication between a wireless AP and one or more wireless STAs.

FIG. 8 shows an example PPDU 810 associated with a first mode of transmission.

FIG. 9 shows an example PPDU 940 associated with a second mode of transmission.

FIG. 10 shows an example PPDU 1070 associated with a third mode of transmission.

FIG. 11 shows a flowchart illustrating an example process performable by a wireless communication device that supports wireless communication of packets with preamble symbols having power boost adjustments.

FIG. 12 shows a flowchart illustrating an example process performable by a wireless communication device that performs a spectral mask analysis.

FIG. 13 is a diagram illustrating an example of a hardware implementation for an apparatus.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an Internet-of-Things (IoT) network.

The IEEE 802.11ax standard supports high-efficiency extended range (HE-ER) packet types to increase the range of Wi-Fi signals. However, one of the main limitations of HE-ER is that it relies on the ability of the receiver to correctly decode a preamble of the packet. The preamble is a sequence of symbols that is transmitted at the beginning of each packet and is used to synchronize the receiver with the incoming signal. Preamble symbols are designed to have a high power level to ensure that they can be received by the receiver even in a noisy environment. In HE-ER, the preamble is typically longer than in traditional Wi-Fi packets, which allows for more accurate synchronization but also increases the chances of errors during the decoding process. However, in some cases, even with high power levels, the preamble decode probability may be low due to various factors such as interference, fading, or multipath. For example, other wireless devices or other sources of interference can cause errors in the preamble, making it difficult for the receiver to decode the packet correctly. As such, due to the preamble decode limitations, the range increase offered by HE-ER packets cannot be realized.

One technique to improve the preamble decode probability is by power boosting specific preamble symbols. This can be done by increasing the power of certain preamble symbols that are more susceptible to noise or fading. By doing so, the signal-to-noise ratio (SNR) of these symbols is increased, making it more likely that they will be correctly decoded by the receiver. For example, if the preamble of a Wi-Fi signal consists of 16 symbols, and it is observed that symbols 8 and 9 are more susceptible to noise, then the power of these symbols can be increased to improve the preamble decode probability. This can be done by adjusting the power amplifier in the transmitter to increase the power of symbols 8 and 9.

However, a preamble symbol with a high peak-to-average power ratio (PAPR) due to power boosting of the preamble symbol can cause a spectral mask violation because the high peak power can produce signals outside of the allowed frequency band and exceed regulatory limits on the maximum power that can be transmitted. This can cause interference with other wireless devices operating in the same frequency bands. The present disclosure provides for power boosting specific preamble symbols as an approach to address the preamble decode limitation while adhering to error vector magnitude (EVM) and spectral mask requirements.

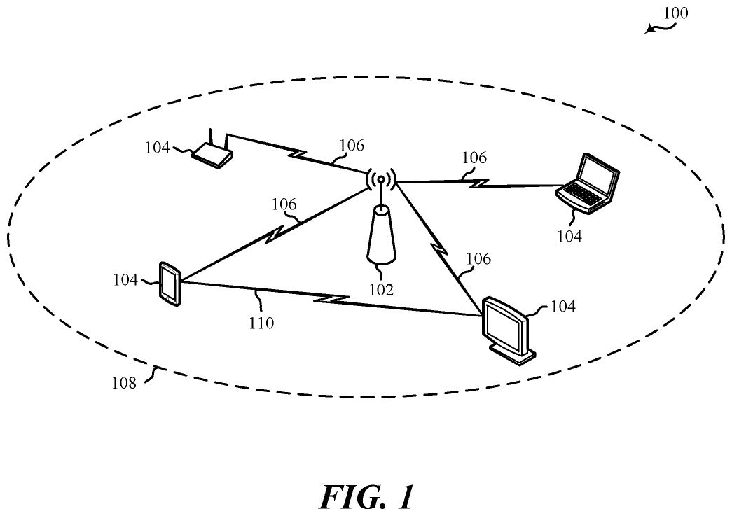

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an AP 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), cameras, music or other audio or stereo devices, remote control devices (“remotes”), printers, kitchen or other household appliances, key fobs (for example, for passive keyless entry and start (PKES) systems), among other possibilities. In some examples, the STA 104 also may be referred to as a wireless device implemented as, or at least included as part of, a drone or unmanned aerial vehicle (UAV), a long-rage Internet-of-Things (IoT) device (e.g., closed-circuit television (CCTV) camera), or battery-operated IoT devices.

A single AP 102 and an associated set of STAs 104 may be referred to as a basic service set (BSS), which is managed by the respective AP 102. FIG. 1 additionally shows an example coverage area 108 of the AP 102, which may represent a basic service area BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (Tus) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such aspects, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and MAC layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some aspects of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

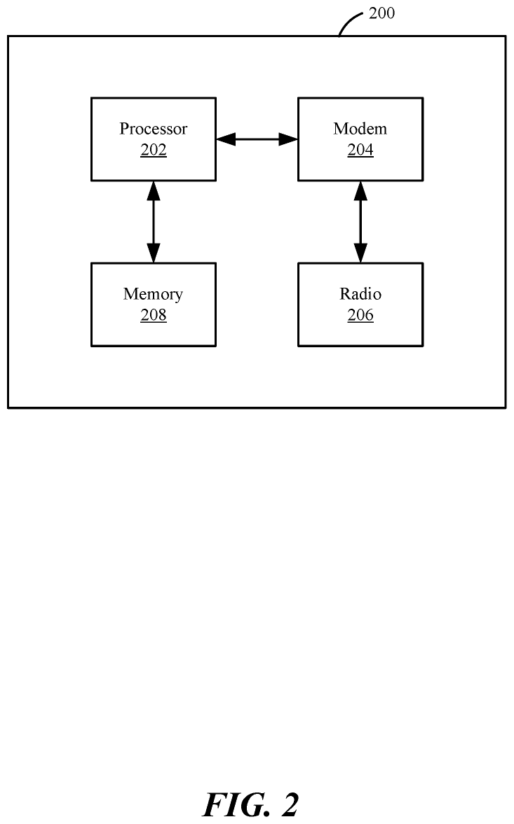

FIG. 2 shows a block diagram of an example wireless communication device 200. In some implementations, the wireless communication device 200 can be an example of a device for use in a STA such as one of the STAs 104 described with reference to FIG. 1. In some implementations, the wireless communication device 200 can be an example of a device for use in an AP such as the AP 102 described with reference to FIG. 1. The wireless communication device 200 is capable of transmitting (or outputting for transmission) and receiving wireless communications (for example, in the form of wireless packets). For example, the wireless communication device 200 can be configured to transmit and receive packets in the form of physical layer convergence protocol (PLCP) protocol data units (PPDUs) and MAC protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 200 can be, or can include, a chip, system on chip (SoC), chipset, package or device that includes one or more modems 204, for example, a Wi-Fi (IEEE 802.11 compliant) modem. In some implementations, the one or more modems 204 (collectively “the modem 204”) additionally include a WWAN modem (for example, a 3GPP 4G LTE or 5G compliant modem). In some implementations, the wireless communication device 200 also includes one or more radios 206 (collectively “the radio 206”). In some implementations, the wireless communication device 200 further includes one or more processors, processing blocks or processing elements 202 (collectively “the processor 202”) and one or more memory blocks or elements 208 (collectively “the memory 208”).

The modem 204 can include an intelligent hardware block or device such as, for example, an application-specific integrated circuit (ASIC) among other possibilities. The modem 204 is generally configured to implement a PHY layer. For example, the modem 204 is configured to modulate packets and to output the modulated packets to the radio 206 for transmission over the wireless medium. The modem 204 is similarly configured to obtain modulated packets received by the radio 206 and to demodulate the packets to provide demodulated packets. In addition to a modulator and a demodulator, the modem 204 may further include digital signal processing (DSP) circuitry, automatic gain control (AGC), a coder, a decoder, a multiplexer and a demultiplexer. For example, while in a transmission mode, data obtained from the processor 202 is provided to a coder, which encodes the data to provide encoded bits. The encoded bits are then mapped to points in a modulation constellation (using a selected MCS) to provide modulated symbols. The modulated symbols may then be mapped to a number N_{SS}of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 206. In implementations involving beamforming, the modulated symbols in the respective spatial streams are pre-coded via a steering matrix prior to their provision to the IFFT block.

While in a reception mode, digital signals received from the radio 206 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 202) for processing, evaluation or interpretation.

The radio 206 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 200 can include, or be coupled with, multiple transmit antennas (each with a corresponding transmit chain) and multiple receive antennas (each with a corresponding receive chain). The symbols output from the modem 204 are provided to the radio 206, which then transmits the symbols via the coupled antennas. Similarly, symbols received via the antennas are obtained by the radio 206, which then provides the symbols to the modem 204.

The processor 202 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 202 processes information received through the radio 206 and the modem 204, and processes information to be output through the modem 204 and the radio 206 for transmission through the wireless medium. For example, the processor 202 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 202 may generally control the modem 204 to cause the modem to perform various operations described above.

The memory 208 can include tangible storage media such as random-access memory (RAM) or read-only memory (ROM), or combinations thereof. The memory 208 also can store non-transitory processor-or computer-executable software (SW) code containing instructions that, when executed by the processor 202, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

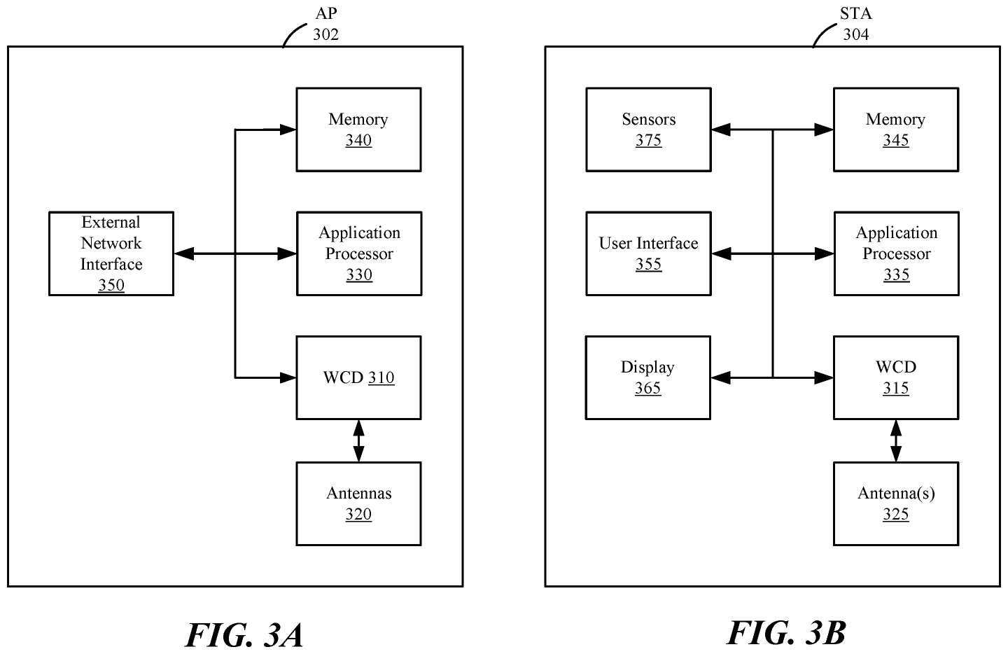

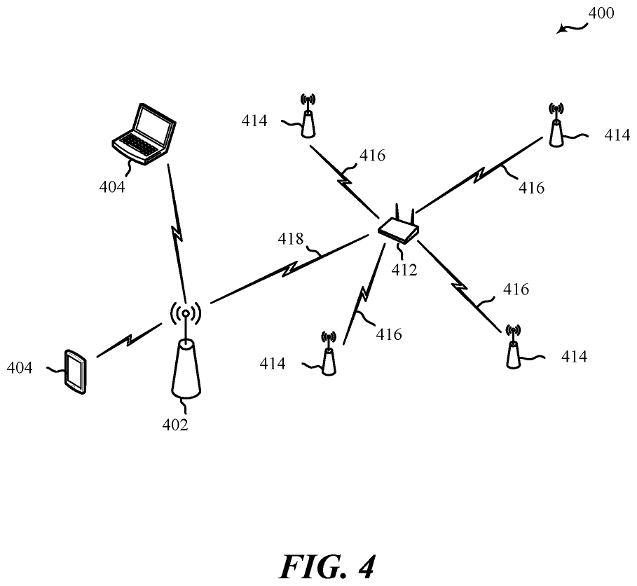

FIG. 3A shows a block diagram of an example AP 302. For example, the AP 302 can be an example implementation of the AP 102 described with reference to FIG. 1. The AP 302 includes a wireless communication device (WCD) 310 (although the AP 302 may itself also be referred to generally as a wireless communication device as used herein). For example, the wireless communication device 310 may be an example implementation of the wireless communication device 400 described with reference to FIG. 4. The AP 302 also includes multiple antennas 320 coupled with the wireless communication device 310 to transmit and receive wireless communications. In some implementations, the AP 302 additionally includes an application processor 330 coupled with the wireless communication device 310, and a memory 340 coupled with the application processor 330. The AP 302 further includes at least one external network interface 350 that enables the AP 302 to communicate with a core network or backhaul network to gain access to external networks including the Internet. For example, the external network interface 350 may include one or both of a wired (for example, Ethernet) network interface and a wireless network interface (such as a WWAN interface). Ones of the aforementioned components can communicate with other ones of the components directly or indirectly, over at least one bus. The AP 302 further includes a housing that encompasses the wireless communication device 310, the application processor 330, the memory 340, and at least portions of the antennas 320 and external network interface 350.

FIG. 3B shows a block diagram of an example STA 304. For example, the STA 304 can be an example implementation of the STA 104 described with reference to FIG. 1. The STA 304 includes a wireless communication device 315 (although the STA 304 may itself also be referred to generally as a wireless communication device as used herein). For example, the wireless communication device 315 may be an example implementation of the wireless communication device 200 described with reference to FIG. 2. The STA 304 also includes one or more antennas 325 coupled with the wireless communication device 315 to transmit and receive wireless communications. The STA 304 additionally includes an application processor 335 coupled with the wireless communication device 315, and a memory 345 coupled with the application processor 335. In some implementations, the STA 304 further includes a user interface (UI) 355 (such as a touchscreen or keypad) and a display 365, which may be integrated with the UI 355 to form a touchscreen display. In some implementations, the STA 304 may further include one or more sensors 375 such as, for example, one or more inertial sensors, accelerometers, temperature sensors, pressure sensors, or altitude sensors. Ones of the aforementioned components can communicate with other ones of the components directly or indirectly, over at least one bus. The STA 304 further includes a housing that encompasses the wireless communication device 315, the application processor 335, the memory 345, and at least portions of the antennas 325, UI 355, and display 365.

Various aspects described herein relate generally to reducing power consumption in an AP, and more particularly, to introducing a power save protocol (for example, lower power mode) for an AP. In some aspects, an AP may initiate a low power mode for reducing power consumption while still maintaining minimal receive (RX) and transmit (TX) functionality. A wireless STA may then request for the AP to transition from the lower power mode to a higher power mode in which the link associated with the AP is enabled for the wireless STA with a minimal delay.

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

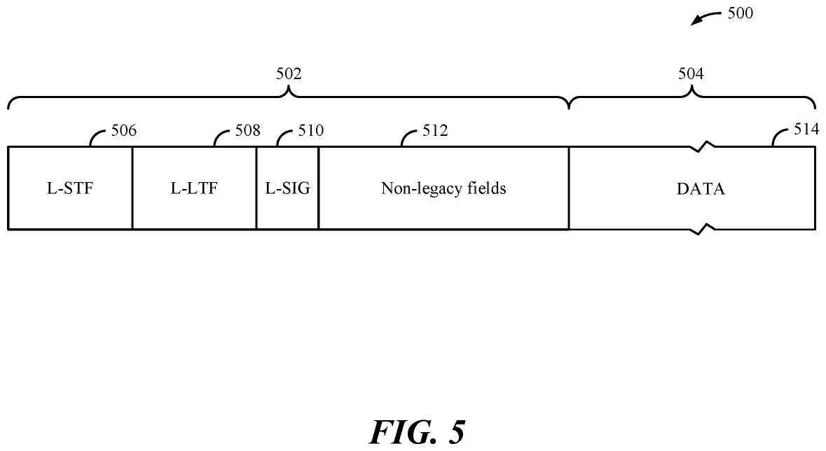

FIG. 5 shows an example protocol data unit (PDU) 500 usable for wireless communication between a wireless AP 102 and one or more wireless STAs 104. For example, the PDU 500 can be configured as a PPDU. As shown, the PDU 500 includes a PHY preamble 502 and a PHY payload 504. For example, the preamble 502 may include a legacy portion that itself includes a legacy short training field (L-STF) 506, which may consist of two symbols, a legacy long training field (L-LTF) 508, which may consist of two symbols, and a legacy signal field (L-SIG) 510, which may consist of two symbols or one symbol. The legacy portion of the preamble 502 may be configured according to the IEEE 802.11a wireless communication protocol standard. The preamble 502 also may include a non-legacy portion including one or more non-legacy fields 512, for example, conforming to one or more of the IEEE 802.11 family of wireless communication protocol standards.

The L-STF 506 generally enables a receiving device to perform coarse timing and frequency tracking and automatic gain control (AGC). The L-LTF 508 generally enables a receiving device to perform fine timing and frequency tracking and also to perform an initial estimate of the wireless channel. The L-SIG 510 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 506, the L-LTF 508 and the L-SIG 510, may be modulated according to a binary phase shift keying (BPSK) modulation scheme. The payload 504 may be modulated according to a BPSK modulation scheme, a quadrature BPSK (Q-BPSK) modulation scheme, a quadrature amplitude modulation (QAM) modulation scheme, or another appropriate modulation scheme. The payload 504 may include a PSDU including a data field (DATA) 514 that, in turn, may carry higher layer data, for example, in the form of MAC protocol data units (MPDUs) or an aggregated MPDU (A-MPDU).

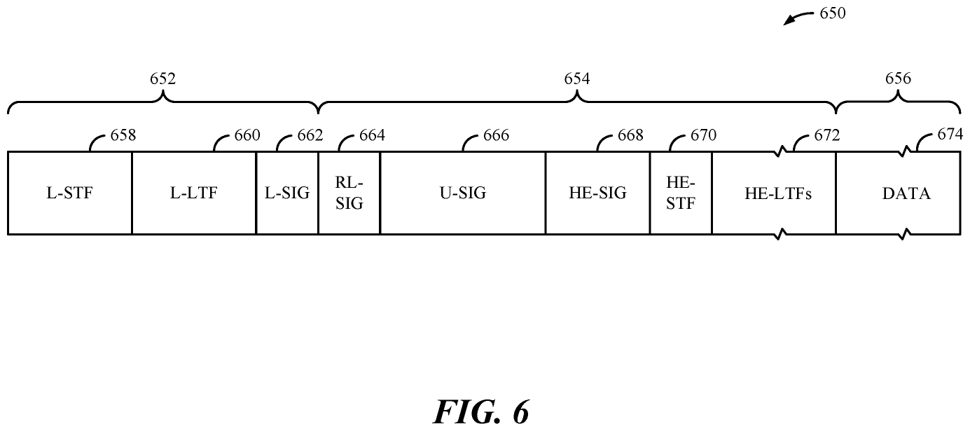

FIG. 6 shows another example PPDU 650 usable for wireless communication between a wireless AP and one or more wireless STAs. The PPDU 650 may be used for SU, OFDMA or MU-MIMO transmissions. In some implementations, the PPDU 650 may be formatted as an High-Efficiency (HE) Extended Range (ER) WLAN PPDU in accordance with IEEE 802.11ax. In other implementations, the PPDU 650 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 650 includes a PHY preamble including a legacy portion 652 and a non-legacy portion 654. The PPDU 650 may further include a PHY payload 656 after the preamble, for example, in the form of a PSDU including a data field 674.

The legacy portion 652 of the preamble includes an L-STF 658, an L-LTF 660, and an L-SIG 662. The non-legacy portion 654 of the preamble includes a repetition of L-SIG (RL-SIG) 664 and multiple wireless communication protocol version-dependent signal fields after RL-SIG 664. For example, the non-legacy portion 654 may include either a universal signal field 666 (referred to herein as “U-SIG 666”) or an HE signal field 668 (referred to herein as “HE-SIG 668”). The presence of RL-SIG 664 and U-SIG 666 may indicate to HE- or later version-compliant STAs 104 that the PPDU 650 is an HE PPDU or a PPDU conforming to any later (post-HE) version of a new wireless communication protocol conforming to a future IEEE 802.11 wireless communication protocol standard. One or both of U-SIG 666 and HE-SIG 668 may be structured as, and carry version-dependent information for, other wireless communication protocol versions associated with amendments to the IEEE family of standards beyond HE. For example, U-SIG 666 may be used by a receiving device to interpret bits in one or more of HE-SIG 668 or the data field 674. Like L-STF 658, L-LTF 660, and L-SIG 662, the information in U-SIG 666 and HE-SIG 668 may be duplicated and transmitted in each of the component 20 MHz channels in instances involving the use of a bonded channel.

The non-legacy portion 654 further includes an additional short training field 670 (referred to herein as “HE-STF 670,” although it may be structured as, and carry version-dependent information for, other wireless communication protocol versions beyond HE) and one or more additional long training fields 672 (referred to herein as “HE-LTFs 672,” although they may be structured as, and carry version-dependent information for, other wireless communication protocol versions beyond HE). HE-STF 670 may be used for timing and frequency tracking and AGC, and HE-LTF 672 may be used for more refined channel estimation.

HE-SIG 668 may be used by an AP to identify and inform one or multiple STAs 104 that the AP has scheduled UL or DL resources for them. HE-SIG 668 may be decoded by each compatible STA 104 served by the AP 102. HE-SIG 668 may generally be used by a receiving device to interpret bits in the data field 674. For example, HE-SIG 668 may include RU allocation information, spatial stream configuration information, and per-user (for example, STA-specific) signaling information. Each HE-SIG 668 may include a common field and at least one user-specific field. In the context of OFDMA, the common field can indicate RU distributions to multiple STAs 104, indicate the RU assignments in the frequency domain, indicate which Rus are allocated for MU-MIMO transmissions and which Rus correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding Rus in the associated data field 674.

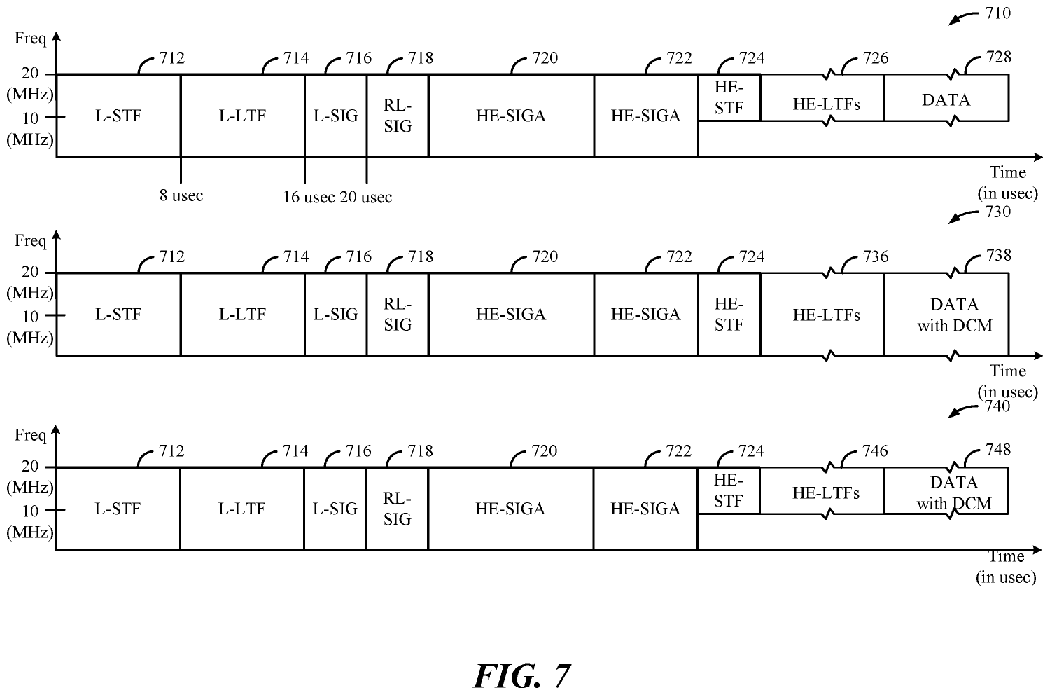

FIG. 7 shows different example PPDUs usable for wireless communication between a wireless AP and one or more wireless STAs. In an aspect, FIG. 7 shows an example PPDU 710 associated with a first mode of transmission. The first mode of transmission may be implemented as HE-ER RU106. The HE-ER RU106 mode of transmission is a feature of HE-ER that allows for a more efficient use of the available bandwidth. RU106 may refer to “Resource Unit 106,” which is a specific unit of bandwidth in HE-ER. The HE-ER RU106 mode uses OFDM to divide the available bandwidth into 106 smaller subcarriers, which are then modulated with data to create the HE-ER packet. This allows for less data to be transmitted in a given amount of time, which results in a stronger signal that can travel farther. In some aspects, the HE-ER packet may refer to the PPDU 710.

The PPDU 710 may be implemented similar to the PPDU 650 of FIG. 6. The PPDU 710 includes a PHY preamble including an L-STF 712, an L-LTF 714, an L-SIG 716, RL-SIG 718, HE-SIGA 720, HE-SIGA 722, HE-STF 724, and HE-LTF 726. The PPDU 710 may further include a PHY payload after the preamble, for example, in the form of a PSDU including a data field 728.

By way of the HE-ER RU106 mode of transmission, the PPDU 710 includes some fields that receive a power boost for transmission. For example, the L-STF 712, L-LTF 714, HE-STF 724, HE-LTFs 726 and data field 728 receive a power boost of 3 dB relative to the transmission power of a HE single-user (SU) packet type. The data included in the data field 728 receives a 3 dB power boost as only half the bandwidth is transmitted. However, due to preamble decode limitations (or receiver sensitivity limitations) of certain preamble symbols (e.g., L-SIG 716, RL-SIG 718, HE-SIGA 720, 722) in the PPDU 710, a gain realized by the PPDU 710 with respect to the HE-SU packet type transmission power for an additive white Gaussian noise (AWGN) channel may be less than the expected gain with respect to HE-SU. In some aspects, another gain may be realized by the PPDU 740 for a dual-non-line-of-sight (DNLOS) channel. These preamble symbols L-SIG 716, RL-SIG 718, HE-SIGA 720, HE-SIGA 722 in the HE-ER RU106 transmit mode are not power boosted alike the other preamble symbols because the preamble symbols L-SIG 716, RL-SIG 718, HE-SIGA 720, HE-SIGA 722 have a higher PAPR and power boosting these preamble symbols can cause spectral mask violations.

In another aspect, FIG. 7 shows an example PPDU 730 associated with a second mode of transmission. The second mode of transmission may be implemented as HE-ER RU242 with dual carrier modulation (DCM). The HE-ER RU242 mode of transmission divides the available bandwidth into 242 smaller subcarriers, which are then modulated with data to create the HE-ER packet, and using advanced error correction algorithms that can help to improve the reliability of the signal over long distances. In addition to RU242, DCM is used to reduce the data rate and increase range.

The PPDU 730 may be implemented similar to the PPDU 650 of FIG. 6. The PPDU 730 includes a PHY preamble including an L-STF 712, an L-LTF 714, an L-SIG 716, RL-SIG 718, HE-SIGA 720, HE-SIGA 722, HE-STF 724, and HE-LTF 736. The PPDU 730 may further include a PHY payload with DCM after the preamble, for example, in the form of a PSDU with DCM including a data field 738.

By way of the HE-ER RU242 with DCM mode of transmission, the PPDU 730 includes some fields that receive a power boost for transmission. For example, the L-STF 712, L-LTF 714, and HE-STF 724 receive a power boost of 3 dB relative to the transmission power of a HE-SU packet type. The data included in the data field 728 may receive a 3 dB gain by way of the DCM modulation. In DCM, the same data is being transmitted over two independent carriers such that the actual data rate is reduced in half. This means that the total data rate is half the data rate of a single carrier system. As a result, the signal-to-noise ratio (SNR) may be increased by about 3 dB. In order to obtain the Log-Likelihood Ratio (LLR) for each bit of the data streams, the information from the two tones (or carriers) are to be combined using, for example, a maximum ratio combining (MRC) technique. MRC can involve combining the received signals from the two tones by weighting them according to their respective SNR. The weighting factor for each tone is inversely proportional to the noise power on that tone. After the information from the two tones is combined, the LLRs can be obtained by passing the combined signal through a demodulator, such as a soft-decision demodulator. The demodulator can compare the combined signal to a threshold and assign a value of 1 or 0 to each bit of the data stream.

However, due to preamble decode limitations (or receiver sensitivity limitations) of certain preamble symbols (e.g., L-SIG 716, RL-SIG 718, HE-SIGA 720, 722) in the PPDU 730, the gain realized by the PPDU 730 with respect to the HE-SU packet type transmission power for an AWGN channel may be less than the expected gain with respect to HE-SU. These preamble symbols L-SIG 716, RL-SIG 718, HE-SIGA 720, HE-SIGA 722, HE-LTFs 736 boosted by 3 dB, data field 738 in the HE-ER RU242 with DCM transmit mode are not power boosted alike the other preamble symbols because the preamble symbols L-SIG 716, RL-SIG 718, HE-SIGA 720, HE-SIGA 722 have a higher PAPR and power boosting these preamble symbols can cause spectral mask violations.

In an aspect, FIG. 7 shows an example PPDU 740 associated with a third mode of transmission. The third mode of transmission may be implemented as HE-ER RU106 with DCM. The HE-ER RU 106 mode divides the available bandwidth into 106 smaller subcarriers, and uses DCM modulation in the data field to decrease the data rate.

The PPDU 740 may be implemented similar to the PPDU 650 of FIG. 6. The PPDU 740 includes a PHY preamble including an L-STF 712, an L-LTF 714, an L-SIG 716, RL-SIG 718, HE-SIGA 720, HE-SIGA 722, HE-STF 724, and HE-LTF 746. The PPDU 740 may further include a PHY payload with DCM after the preamble, for example, in the form of a PSDU with DCM modulation in a data field 748 to decrease data rate.

By way of the HE-ER RU106 with DCM mode of transmission, the PPDU 740 includes some fields that receive a power boost for transmission. For example, the L-STF 712, L-LTF 714, HE-STF 724, HE-LTFs 746 and data field 748 receive a power spectral density (PSD) boost of 3 dB relative to the transmission power of a HE-SU packet type. It should be noted that PSD and power boost may be used interchangeably. The data included in the data field 728 receives a 3 dB PSD boost as only half the bandwidth is transmitted, and also receives a 3 dB gain by way of the DCM modulation, for a total of about 6 dB in sensitivity gain. However, due to preamble decode limitations (or receiver sensitivity limitations) of certain preamble symbols (e.g., L-STF 712 and L-LTF 714 (for packet detection), L-SIG 716, RL-SIG 718, HE-SIGA 720, 722) in the PPDU 740, the gain realized by the PPDU 740 with respect to the HE-SU packet type transmission power for an AWGN channel may be less than the expected gain with respect to HE-SU i. These preamble symbols L-SIG 716, RL-SIG 718, HE-SIGA 720, HE-SIGA 722 in the HE-ER RU106 with DCM transmit mode are not power boosted alike the other preamble symbols because the preamble symbols L-SIG 716, RL-SIG 718, HE-SIGA 720, HE-SIGA 722 have a higher PAPR and power boosting these preamble symbols can cause spectral mask violations.

As shown above, each of the PPDUs 710, 730 and 740 include preamble symbols that cause a bottleneck in the expected realized gain, and thus, are likely to have preamble decode limitations. However, as briefly discussed above, applying a power boost to each of these preamble symbols causing the bottleneck can result in preamble symbols with a high PAPR, which in turn can cause a spectral mask violation because the high peak power can produce signals outside of the allowed frequency band and exceed regulatory limits on the maximum power that can be transmitted. As such, a technique to apply power boosting to specific preamble symbols to address the preamble decode limitation while adhering to EVM and spectral mask requirements is desirable.

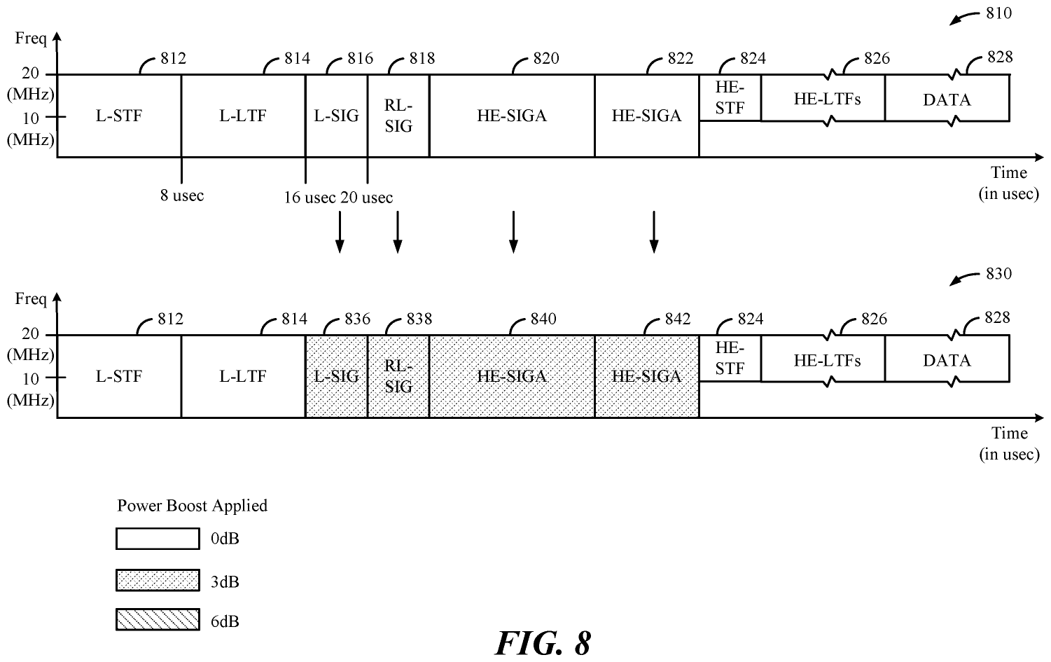

FIG. 8 shows an example PPDU 810 associated with a first mode of transmission. In some aspects, the first mode of transmission may be implemented as HE-ER RU106. The PPDU 810 may be implemented similar to the PPDU 710 of FIG. 7. The PPDU 810 includes a PHY preamble including an L-STF 812, an L-LTF 814, an L-SIG 816, RL-SIG 818, HE-SIGA 820, HE-SIGA 822, HE-STF 824, and HE-LTF 826. The PPDU 810 may further include a PHY payload after the preamble, for example, in the form of a PSDU including a data field 828.

Given that the mode of transmission of the PPDU 810 is HE-ER RU106, the preamble symbols L-SIG 816, RL-SIG 818, HE-SIGA 820 and HE-SIGA 822 causes a bottleneck in the overall gain realized (e.g., with reference to the preamble decode limitations of the PPDU 710 of FIG. 7). To address the preamble decode limitations, the PPDU 810 can receive additional power boost to these identified preamble symbols. For example, a power boost can be applied to each of the preamble symbols L-SIG 816, RL-SIG 818, HE-SIGA 820 and HE-SIGA 822 by increasing the transmission power of each of these preamble symbols by a predetermined power boost value, e.g., 3 dB, to match the data sensitivity. In this regard, the sensitivity of these preamble symbols L-SIG 816, RL-SIG 818, HE-SIGA 820 and HE-SIGA 822 in the PPDU 810 can be adjusted to match the data sensitivity of the data field 828. FIG. 8 also illustrates an example PPDU 830 that includes the preamble symbols L-SIG 836, RL-SIG 838, HE-SIGA 840 and HE-SIGA 842 with the applied power boost to overcome the preamble decode limitations discussed with reference to the PPDU 810.

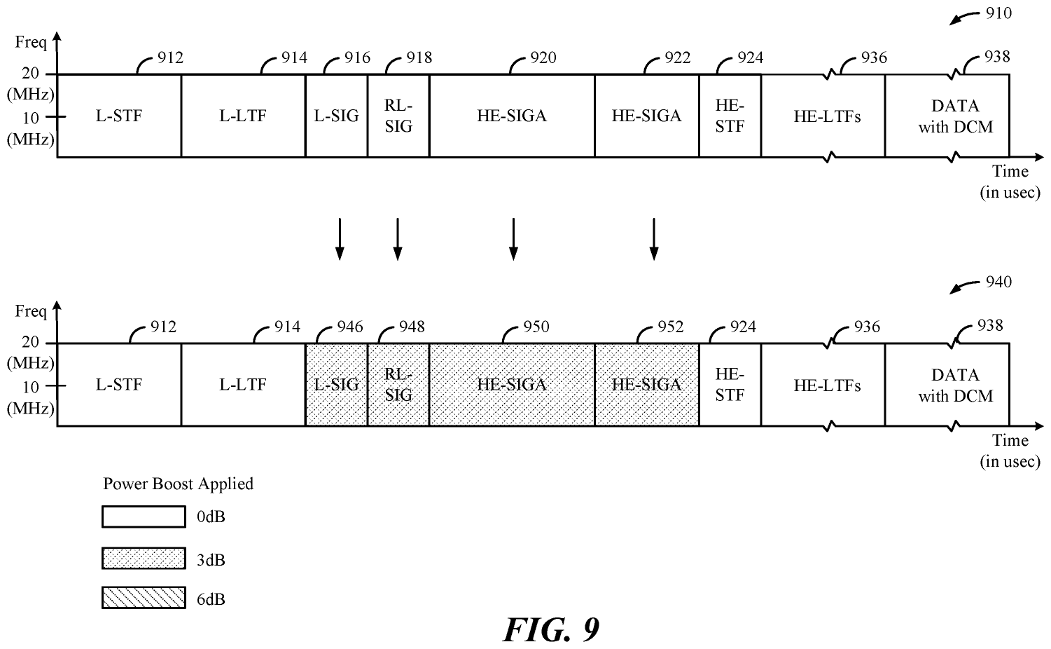

FIG. 9 shows an example PPDU 940 associated with a second mode of transmission. In some aspects, the second mode of transmission may be implemented as HE-ER RU242. The PPDU 910 may be implemented similar to the PPDU 730 of FIG. 7. The

PPDU 910 includes a PHY preamble including an L-STF 912, an L-LTF 914, an L-SIG 916, RL-SIG 918, HE-SIGA 920, HE-SIGA 922, HE-STF 924, and HE-LTF 936. The PPDU 910 may further include a PHY payload after the preamble, for example, in the form of a PSDU including a data field 938.

Given that the mode of transmission of the PPDU 910 is HE-ER RU242 with DCM, the preamble symbols L-SIG 916, RL-SIG 918, HE-SIGA 920 and HE-SIGA 922 are known to cause a bottleneck in the overall gain realized (e.g., with reference to the preamble decode limitations of the PPDU 730 of FIG. 7). To address the preamble decode limitations, the PPDU 910 can receive additional power boost to these identified preamble symbols. For example, a power boost can be applied to each of the preamble symbols L-SIG 916, RL-SIG 918, HE-SIGA 920 and HE-SIGA 922 by increasing the transmission power of each of these preamble symbols by a predetermined power boost value, e.g., 3 dB, to match the data sensitivity. In this regard, the sensitivity of these preamble symbols L-SIG 916, RL-SIG 918, HE-SIGA 920 and HE-SIGA 922 in the PPDU 910 can be adjusted to match the data sensitivity of the data field 928. FIG. 9 also illustrates an example PPDU 940 that includes the preamble symbols L-SIG 946, RL-SIG 948, HE-SIGA 950 and HE-SIGA 952 with the applied power boost to overcome the preamble decode limitations discussed with reference to the PPDU 910.

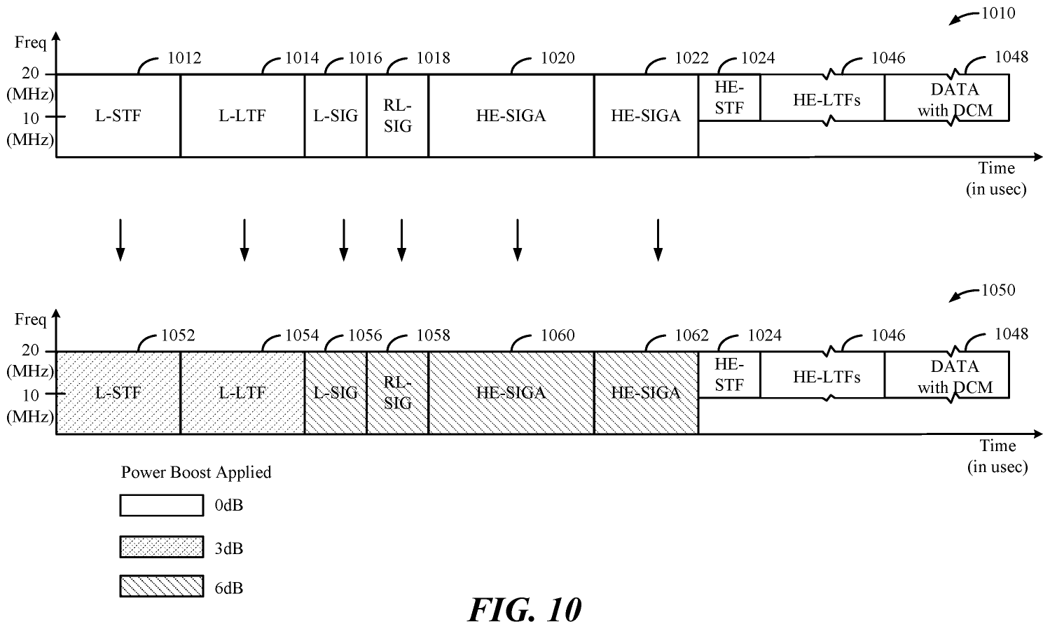

FIG. 10 shows an example PPDU 1010 associated with a third mode of transmission. In some aspects, the first mode of transmission may be implemented as HE-ER RU106 with DCM for data. The PPDU 1010 may be implemented similar to the PPDU 740 of FIG. 7. The PPDU 1010 includes a PHY preamble including an L-STF 1012, an L-LTF 1014, an L-SIG 1016, RL-SIG 1018, HE-SIGA 1020, HE-SIGA 1022, HE-STF 1024, and HE-LTF 1046. The PPDU 1010 may further include a PHY payload with RU106 with DCM for data after the preamble, for example, in the form of a PSDU including a data field 1048.

Given that the mode of transmission of the PPDU 1010 is HE-ER RU106 with DCM, the preamble symbols L-STF 1012, L-LTF 1014, L-SIG 1016, RL-SIG 1018, HE-SIGA 1020 and HE-SIGA 1022 causes a bottleneck in the overall gain realized (e.g., with reference to the preamble decode limitations of the PPDU 740 of FIG. 7). To address the preamble decode limitations, the PPDU 1010 can receive additional power boost to these identified preamble symbols. For example, a power boost can be applied to each of the preamble symbols L-SIG 1016, RL-SIG 1018, HE-SIGA 1020 and HE-SIGA 1022 by increasing the transmission power of each of these preamble symbols by a predetermined power boost value, e.g., 6 dB, to match the data sensitivity. Additionally, the other preamble symbols L-STF 1012 and L-LTF 1014 receive an additional power boost of about 3 dB to match the data sensitivity of 6 dB. In this regard, the sensitivity of these preamble symbols L-STF 1012, L-LTF 1014, L-SIG 1016, RL-SIG 1018, HE-SIGA 1020 and HE-SIGA 1022 in the PPDU 1010 can be adjusted to match the data sensitivity of the data field 1028. FIG. 10 also illustrates an example PPDU 1050 that includes the preamble symbols L-STF 1052, L-LTF 1054, L-SIG 1056, RL-SIG 1058, HE-SIGA 1060 and HE-SIGA 1062 with the applied power boost to overcome the preamble decode limitations discussed with reference to the PPDU 1010.

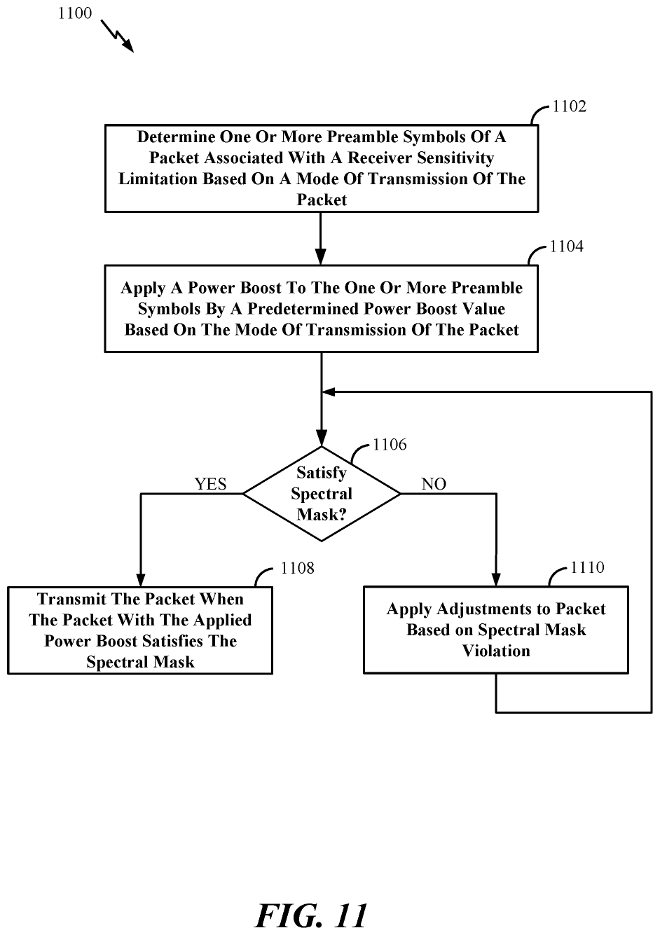

FIG. 11 shows a flow chart illustrating an example process performable by a wireless communication device that supports wireless communication of packets with preamble symbols having power boost adjustments. In some implementations, the process 1200 may be performed at a wireless STA, such as one of the STAs 104 of FIG. 1, the STA 304 or WCD 315 of FIG. 3B, or the STA 404 of FIG. 4. According to various different aspects, one or more of the illustrated blocks of process 1200 may be omitted, transposed, or contemporaneously performed. In such process 1200, blocks 1102, 1104, 1106 and 1108 are performed as described above in connection to FIG. 11.

In an aspect, the process 1100 includes block 1102 that includes determining one or more preamble symbols of a packet based on a mode of transmission of the packet, the one or more preamble symbols of the packet being associated with a receiver sensitivity limitation. In the context of FIG. 4, block 1102 may be illustrated by the STA 404 determining the one or more preamble symbols of a packet associated with a receiver sensitivity limitation.

In an aspect, the process 1100 includes block 1104 that includes applying a power boost to the one or more preamble symbols by a power boost value, the power boost value being based on the mode of transmission of the packet. In the context of FIG. 4, block 1104 may be illustrated by the STA 404 applying the power boost to the one or more preamble symbols by the power boost value. In some aspects, the power boost value is a first value (e.g., 3 dB) that may be programmable. In other aspects, the power boost value is a second value (e.g., 6 dB) that may also be programmable and boosted arbitrarily.

As discussed above with reference to FIG. 7, applying a power boost to certain preamble symbols causing receiver sensitivity limitations can result in preamble symbols with a high PAPR, which in turn can cause a spectral mask violation because the high peak power can produce signals outside of the allowed frequency band and exceed regulatory limits on the maximum power that can be transmitted. This can be caused because of saturation at the power amplifier and/or excessive clipping at baseband (e.g., PAPR reduction algorithms). As such, the present disclosure provides for a technique to detect the possible spectral mask violations and apply adjustments to the packet to adhere to the transmission power limit.

In an aspect, the process 1100 includes block 1106 that includes determining whether the one or more preamble symbols with the applied power boost satisfy a spectral mask. The spectral mask in Wi-Fi transmission is a filter that is used to limit the frequency range of a signal. It is used to ensure that the signal does not interfere with other signals that are present in the same frequency band. In Wi-Fi, the spectral mask is a set of rules that define the maximum allowed power levels for different frequencies within the Wi-Fi band. For example, the spectral mask for the 2.4 GHz Wi-Fi band specifies that the maximum allowed power level for a signal at 2.4 GHz is 20 dBm, while the maximum allowed power level for a signal at 2.5 GHz is 18 dBm. This means that a Wi-Fi transmitter must ensure that the power level of its signal does not exceed these limits at any point within the specified frequency range. The spectral mask is a critical aspect of Wi-Fi transmission as it helps to ensure that Wi-Fi signals do not interfere with other signals that are present in the same frequency band. This is important because Wi-Fi operates in unlicensed frequency bands, which means that many other wireless devices and systems also use the same frequencies. In the context of FIG. 4, block 1106 may be illustrated by the STA 404 determining whether the one or more preamble symbols with the applied power boost satisfy the spectral mask. If the spectral mask is satisfied, then the process 1100 proceeds to block 1108. Otherwise, the process 1100 proceeds to block 1110. In some aspects, adjustments may performed on the packet at block 1106 for addressing possible spectral mask violations. Such adjustments may be based on the PAPR of a preamble symbol, which depends on content of the preamble symbol (e.g., LSIG: length, HESIGA: basic service set (BSS) color, spatial reuse (SR), long-term field guard interval (LTF-GI) and transmission opportunity (TxOP)).

In an aspect, the process 1100 includes block 1108 that includes transmitting the packet when the one or more preamble symbols with the applied power boost satisfy the spectral mask. In the context of FIG. 4, block 1104 may be illustrated by the STA 404 transmitting the packet.

In an aspect, the process 1100 includes block 1110 that includes applying adjustments to the packet based on a spectral mask violation. In the context of FIG. 4, block 1104 may be illustrated by the STA 404 applying the adjustments to the packet. At the conclusion of performing the adjustments to the packet, the process 1100 may proceed back to block 1106 and determine whether the packet with the applied adjustments satisfies the spectral mask. In some aspects, the adjustments may include increasing a packet size of the packet by selecting a next packet size from a set of packet sizes when the packet size of the packet based on content of the one or more preamble symbols with the applied power boost does not correspond to at least one valid packet size. A packet with the valid packet size may not cause a spectral mask violation because the peak-to-average power ratio measurement of the packet having the valid packet size may not exceed a transmission power limit. In some aspects, a valid packet size may be found by storing all the valid packet sizes and implementing a lookup table.

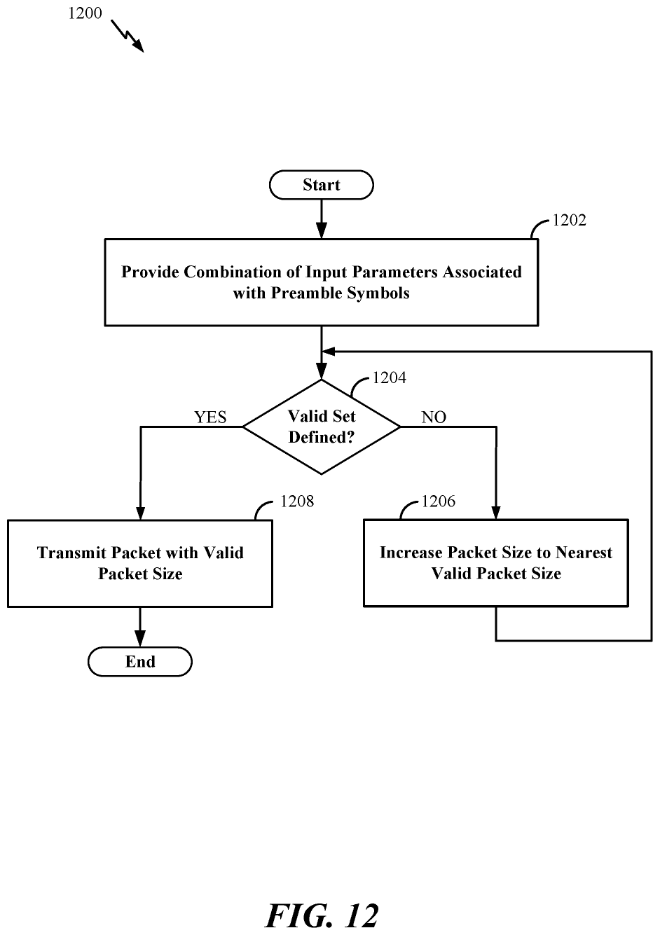

FIG. 12 shows a flow chart illustrating an example process performable by a wireless communication device that performs a spectral mask analysis. In some implementations, the process 1200 may be performed at a wireless STA, such as one of the STAs 104 of FIG. 1, the STA 304 or WCD 315 of FIG. 3B, or the STA 404 of FIG. 4. According to various different aspects, one or more of the illustrated blocks of process 1200 may be omitted, transposed, or contemporaneously performed. In such process 1200, blocks 1202, 1204, 1206 and 1208 are performed as described above in connection to FIG. 12.

In an aspect, the process 1200 includes block 1202 that includes providing a combination of input parameters associated with preamble symbols with an applied power boost. In the context of FIG. 4, block 1202 may be illustrated by the STA 404 providing the combination of input parameters associated with the preamble symbols. In some aspects, the STA 404 may determine the input parameters, which include content of the preamble symbols with the applied power boost.

In an aspect, the process 1200 includes block 1204 that includes determining whether the input parameters correspond to parameters in a valid set of parameters that do not cause a spectral mask violation. The spectral mask can be defined as a limit on the maximum power that can be transmitted in certain frequency bands, and it is used to prevent interference with other wireless devices. For example, the input parameters may be defined as BSS color=0, SR=0, LTF-GI=2x+0.8 and packet size=42 bytes, where 43 bytes is the packet size that causes no spectral mask violation, i.e., a packet size in a valid set. In the context of FIG. 4, block 1204 may be illustrated by the STA 404 determining whether the input parameters correspond to parameters in a valid set of parameters. If the valid set is defined by the input parameters having correspondence to parameters in the valid set of parameters that do not cause a spectral mask violation, then the process 1200 proceeds to block 1208. Otherwise, the process 1200 proceeds to block 1206. For example, a packet size of 42 bytes based on the input parameters would not correspond to a packet size in the valid set (e.g., 43 bytes), so adjustments to the packet would be needed and performed at block 1206.

In an aspect, the process 1200 includes block 1206 that includes increasing a packet size of the packet to a nearest valid packet size when the input parameters do not correspond to parameters in the valid set of parameters that do not cause the spectral mask violation. In some aspects, a valid packet size set is defined as a set of valid packet sizes which causes no mask violation for a given input combination. In the context of FIG. 4, block 1206 may be illustrated by the STA 404 increasing the packet size of the packet to the nearest valid packet size. In some aspects, the STA 404 may further increase the packet size of the packet by selecting a next packet size from the set of packet sizes when the packet size of the packet based on the content of the one or more preamble symbols with the applied power boost does not correspond to at least one valid packet size, and the process 1200 may circle back to block 1204 where the STA 404 may then determine whether the next packet size selected to increase the packet size of the packet corresponds to the at least one valid packet size of the set of packet sizes that does not cause the spectral mask violation. For example, the packet size can be increased from 42 bytes to 43 bytes through padding. The packet size of 43 bytes can be checked to determine if the new packet size is in the valid set, and if so, the 43-byte size is used as the packet size for transmission of the packet.

In an aspect, the process 1200 includes block 1208 that includes transmitting the packet with a valid packet size when the input parameters have correspondence to parameters in the valid set of parameters that do not cause a spectral mask violation. In the context of FIG. 4, block 1208 may be illustrated by the STA 404 transmitting the packet with the valid packet size. In some aspects, the packet is transmitted with an increased packet size. At the completion of the packet transmission, the process 1200 may terminate.

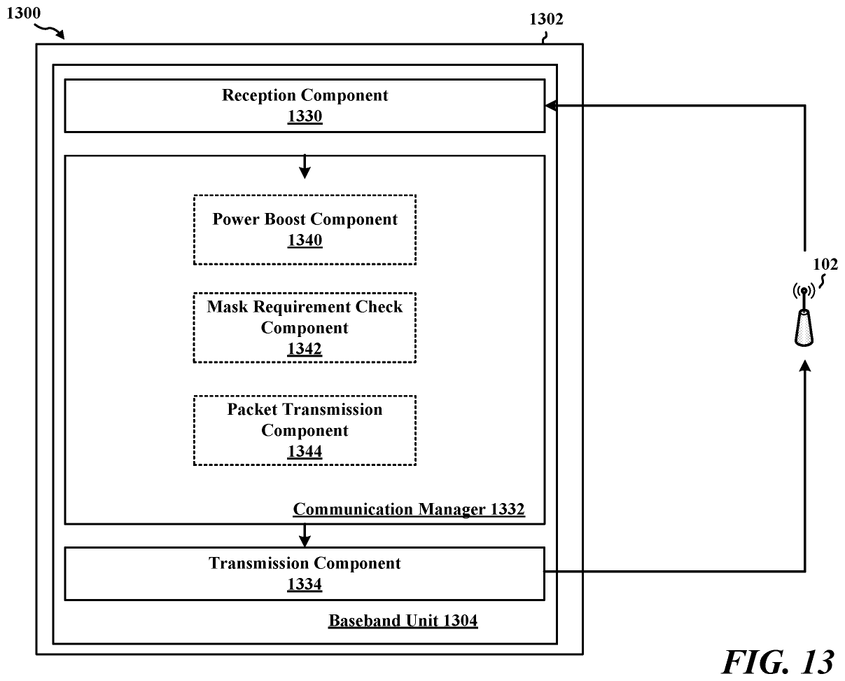

FIG. 13 is a diagram 1300 illustrating an example of a hardware implementation for an apparatus 1302. In some implementations, the apparatus 1302 is configured to perform the process 1100 described above with reference to FIG. 11. In some implementations, the apparatus 1302 may be a chip, SoC, chipset, package, circuitry, device, or system that includes at least one processor and at least one modem, such as a Wi-Fi or IEEE 802.11-compliant modem or a cellular modem.

The apparatus 1302 is a wireless communication device and includes a baseband unit 1304. In some aspects, the apparatus 1302 can be an example implementation of a transmitter device, such as the STA 104 described above with reference to FIG. 1, the STA 304 described above with reference to FIG. 3B, or the STA 404 described above with reference to FIG. 4.

The baseband unit 1304 may communicate through a RF transceiver with a receiver device (e.g., 102 of FIG. 1; 302 of FIG. 3A; 402, 412, 414 of FIG. 4) and any other suitable network nodes. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the STA 304 and may include the memory 345 and/or the application processor 335.

The communication manager 1332 includes a power boost component 1340 configured to determine one or more preamble symbols of a packet based on a mode of transmission of the packet, the one or more preamble symbols of the packet being associated with a receiver sensitivity limitation, e.g., as described in connection with 1102 of FIG. 11. The power boost component 1340 also may be configured to apply a power boost to the one or more preamble symbols by a power boost value, the power boost value being based on the mode of transmission of the packet, e.g., as described in connection with 1104 of FIG. 11.

The communication manager 1332 further includes a mask requirement check component 1342 configured to determine whether the one or more preamble symbols with the applied power boost satisfy a spectral mask; e.g., as described in connection with 1106 of FIG. 11.

The communication manager 1332 further includes a packet transmission component 1344 configured to transmit the packet when the one or more preamble symbols with the applied power boost satisfy the spectral mask; e.g., as described in connection with 1108 of FIG. 11.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for means for determining one or more preamble symbols of a packet based on a mode of transmission of the packet, the one or more preamble symbols of the packet being associated with a receiver sensitivity limitation. The baseband unit 1304 also includes means for means for applying a power boost to the one or more preamble symbols by a power boost value, the power boost value being based on the mode of transmission of the packet. The baseband unit 1304 also includes means for determining whether the one or more preamble symbols with the applied power boost satisfy a spectral mask. The baseband unit 1304 also includes means for transmitting the packet when the one or more preamble symbols with the applied power boost satisfy the spectral mask.

The aforementioned means may be one or more of the aforementioned components of the apparatus 1302 configured to perform the functions recited by the aforementioned means. As described supra, the apparatus 1302 may include the application processor 335, and the WCD 315. As such, in one configuration, the aforementioned means may be the application processor 335, and the WCD 315 configured to perform the functions recited by the aforementioned means.

The aspects described herein additionally include one or more of the following implementation examples described in the following numbered clauses.

Clause 1 is a method of wireless communication performable at a wireless communication device that includes determining one or more preamble symbols of a packet based on a mode of transmission of the packet, the one or more preamble symbols of the packet being associated with a receiver sensitivity limitation; applying a power boost to the one or more preamble symbols by a power boost value, the power boost value being based on the mode of transmission of the packet; determining whether the one or more preamble symbols with the applied power boost satisfy a spectral mask; and transmitting the packet when the one or more preamble symbols with the applied power boost satisfy the spectral mask.

In Clause 2, the method of Clause 1 further includes that the determining whether the one or more preamble symbols with the applied power boost satisfy the spectral mask comprises adjusting a packet size of the packet to a next nearest valid packet size when the one or more preamble symbols with the applied power boost do not satisfy the spectral mask.

In Clause 3, the method of Clause 1 or Clause 2 further includes that the determining the one or more preamble symbols of the packet comprises determining that the one or more preamble symbols includes one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 transmit mode or a HE ER RU 242 with dual carrier modulation (DCM) transmit mode, and wherein the determining whether the one or more preamble symbols with the applied power boost satisfy the spectral mask comprises increasing a transmission power of each of the one or more L-SIG symbols, the one or more RL-SIG symbols and the one or more HE-SIGA symbols by the power boost value.

In Clause 4, the method of any of Clauses 1-3 further includes that the power boost value is a first value that may be programmable.

In Clause 5, the method of any of Clauses 1-4 further includes that the determining the one or more preamble symbols of the packet comprises determining that the one or more preamble symbols includes one or more L-STF symbols, one or more L-LTF symbols, one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 with dual carrier modulation (DCM) transmit mode, and wherein the determining whether the one or more preamble symbols with the applied power boost satisfy the spectral mask comprises increasing a first transmission power of each of the one or more L-STF symbols and the one or more L-LTF symbols by a first power boost value and further increase a second transmission power of each of the one or more L-SIG symbols, the one or more RL-SIG symbols and the one or more HE-SIGA symbols by a second power boost value greater than the first power boost value.

In Clause 6, the method of Clause 5 further includes that the first power boost value is a second value and the second power boost value is a third value, wherein the second value is different than the third value.

In Clause 7, the method of any of Clauses 1-6 further includes that the determining whether the one or more preamble symbols with the applied power boost satisfy the spectral mask comprises determining input parameters comprising content of the one or more preamble symbols with the applied power boost, determining whether the input parameters correspond to parameters in a valid set of parameters that do not cause a spectral mask violation, and increasing a packet size of the packet to nearest valid packet size when the input parameters do not correspond to parameters in the valid set of parameters that do not cause the spectral mask violation.

In Clause 8, the method of Clause 7 further includes that the content includes one or more of length information associated with the one or more L-SIG symbols or the one or more RL-SIG symbols, basic service set (BSS) color information associated with the one or more HE-SIGA symbols, spatial reuse information associated with the one or more HE-SIGA symbols, LTF guard interval (GI) information associated with the one or more HE-SIGA symbols, or transmission opportunity (TxOP) information associated with the one or more HE-SIGA symbols. In some aspects, the length information of the L-SIG field indicates the duration of the PPDU.

In Clause 9, the method of any of Clauses 1-8 further includes that the determining whether the one or more preamble symbols with the applied power boost satisfy the spectral mask comprises determining whether a packet size of the packet based on content of the one or more preamble symbols with the applied power boost corresponds to at least one valid packet size of a set of packet sizes that does not cause a spectral mask violation.

In Clause 10, the method of any of Clauses 1-9 further includes increasing the packet size of the packet to correspond to the at least one valid packet size of the set of packet sizes that does not cause the spectral mask violation, wherein the packet is transmitted with the increased packet size.

Clause 11 is a device including one or more processors and one or more memories in electronic communication with the one or more processors storing instructions executable by the one or more processors to cause a system or an apparatus to implement a method as in any of Clauses 1 to 10.

Clause 12 is a system or apparatus including means for implementing a method or realizing an apparatus as in any of Clauses 1 to 10.

Clause 13 is a non-transitory computer-readable medium storing instructions executable by one or more processors to cause the one or more processors to implement a method as in any of Clauses 1 to 10.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the aspects disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the aspects described in this disclosure may be readily apparent to persons having ordinary skill in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, various features that are described in this specification in the context of separate aspects also can be implemented in combination in a single aspect. Conversely, various features that are described in the context of a single aspect also can be implemented in multiple aspects separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

What is claimed is:

1. A wireless communication device, comprising:
at least one memory; and
at least one processor communicatively coupled with the at least one memory, the at least one processor operable to cause the wireless communication device to:
determine one or more preamble symbols of a packet based on a mode of transmission of the packet, the one or more preamble symbols of the packet being associated with a receiver sensitivity limitation;
apply a power boost to the one or more preamble symbols by a power boost value, the power boost value being based on the mode of transmission of the packet;
determine whether the one or more preamble symbols with the applied power boost satisfy a spectral mask; and
transmit the packet when the one or more preamble symbols with the applied power boost satisfy the spectral mask.

2. The wireless communication device of claim 1, wherein the at least one processor is operable to further cause the wireless communication device to adjust a packet size of the packet to a next nearest valid packet size when the one or more preamble symbols with the applied power boost do not satisfy the spectral mask.

3. The wireless communication device of claim 1, wherein the at least one processor is operable to further cause the wireless communication device to:
determine that the one or more preamble symbols includes one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 transmit mode or a HE ER RU 242 with dual carrier modulation (DCM) transmit mode; and
increase a transmission power of each of the one or more L-SIG symbols, the one or more RL-SIG symbols and the one or more HE-SIGA symbols by the power boost value.

4. The wireless communication device of claim 3, wherein the power boost value is a first value.

5. The wireless communication device of claim 1, wherein the at least one processor is operable to further cause the wireless communication device to:
determine that the one or more preamble symbols includes one or more L-STF symbols, one or more L-LTF symbols, one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 with dual carrier modulation (DCM) transmit mode, and
increase a first transmission power of each of the one or more L-STF symbols and the one or more L-LTF symbols by a first power boost value and further increase a second transmission power of each of the one or more L-SIG symbols, the one or more RL-SIG symbols and the one or more HE-SIGA symbols by a second power boost value greater than the first power boost value.

6. The wireless communication device of claim 4, wherein the first power boost value is a second value and the second power boost value is a third value, wherein the second value and the third value are different.

7. The wireless communication device of claim 5, wherein the at least one processor is operable to further cause the wireless communication device to:
determine input parameters comprising content of the one or more preamble symbols with the applied power boost,
determine whether the input parameters correspond to parameters in a valid set of parameters that do not cause a spectral mask violation, and
increase a packet size of the packet to a nearest valid packet size when the input parameters do not correspond to parameters in the valid set of parameters that do not cause the spectral mask violation.

8. The wireless communication device of claim 7, wherein the content includes one or more of:
length information associated with the one or more L-SIG symbols or the one or more RL-SIG symbols,
basic service set (BSS) color information associated with the one or more HE-SIGA symbols,
spatial reuse information associated with the one or more HE-SIGA symbols, LTF guard interval (GI) information associated with the one or more HE-SIGA symbols, or
transmission opportunity (TxOP) information associated with the one or more HE-SIGA symbols.

9. The wireless communication device of claim 1, wherein the at least one processor is operable to further cause the wireless communication device to: determine whether a packet size of the packet corresponds to at least one valid packet size of a set of packet sizes that does not cause a spectral mask violation, wherein the packet is based on content of the one or more preamble symbols with the applied power boost.

10. The wireless communication device of claim 9, wherein the at least one processor is operable to further cause the wireless communication device to: increase the packet size of the packet to correspond to the at least one valid packet size of the set of packet sizes that does not cause the spectral mask violation,
wherein the packet is transmitted with the increased packet size.

11. A method of wireless communication performable at a wireless communication device, the method comprising:
determining one or more preamble symbols of a packet based on a mode of transmission of the packet, the one or more preamble symbols of the packet being associated with a receiver sensitivity limitation;
applying a power boost to the one or more preamble symbols by a power boost value, the power boost value being based on the mode of transmission of the packet;
determining whether the one or more preamble symbols with the applied power boost satisfy a spectral mask; and
transmitting the packet when the one or more preamble symbols with the applied power boost satisfy the spectral mask.

12. The method of claim 11, wherein the determining whether the one or more preamble symbols with the applied power boost satisfy the spectral mask comprises adjusting a packet size of the packet to a next nearest valid packet size when the one or more preamble symbols with the applied power boost do not satisfy the spectral mask.

13. The method of claim 11, wherein the determining the one or more preamble symbols of the packet comprises determining that the one or more preamble symbols includes one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 transmit mode or a HE ER RU 242 with dual carrier modulation (DCM) transmit mode, and wherein the determining whether the one or more preamble symbols with the applied power boost satisfy the spectral mask comprises increasing a transmission power of each of the one or more L-SIG symbols, the one or more RL-SIG symbols and the one or more HE-SIGA symbols by the power boost value.

14. The method of claim 13, wherein the power boost value is a first value.

15. The method of claim 11, wherein the determining the one or more preamble symbols of the packet comprises determining that the one or more preamble symbols includes one or more L-STF symbols, one or more L-LTF symbols, one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 with dual carrier modulation (DCM) transmit mode, and wherein the determining whether the one or more preamble symbols with the applied power boost satisfy the spectral mask comprises increasing a first transmission power of each of the one or more L-STF symbols and the one or more L-LTF symbols by a first power boost value and further increase a second transmission power of each of the one or more L-SIG symbols, the one or more RL-SIG symbols and the one or more HE-SIGA symbols by a second power boost value greater than the first power boost value.

16. The method of claim 14, wherein the first power boost value is a second value and the second power boost value is a third value, wherein the second value and the third value are different.

17. The method of claim 15, wherein the determining whether the one or more preamble symbols with the applied power boost satisfy the spectral mask comprises:
determining input parameters comprising content of the one or more preamble symbols with the applied power boost,
determining whether the input parameters correspond to parameters in a valid set of parameters that do not cause a spectral mask violation, and
increasing a packet size of the packet to nearest valid packet size when the input parameters do not correspond to parameters in the valid set of parameters that do not cause the spectral mask violation.

18. The method of claim 17, wherein the content includes one or more of:
length information associated with the one or more L-SIG symbols or the one or more RL-SIG symbols,
basic service set (BSS) color information associated with the one or more HE-SIGA symbols,
spatial reuse information associated with the one or more HE-SIGA symbols, LTF guard interval (GI) information associated with the one or more HE-SIGA symbols, or
transmission opportunity (TxOP) information associated with the one or more HE-SIGA symbols.

19. The method of claim 11, wherein the determining whether the one or more preamble symbols with the applied power boost satisfy the spectral mask comprises determining whether a packet size of the packet corresponds to at least one valid packet size of a set of packet sizes that does not cause a spectral mask violation, wherein the packet is based on content of the one or more preamble symbols with the applied power boost.

20. The method of claim 19, further comprising:
increasing the packet size of the packet to correspond to the at least one valid packet size of the set of packet sizes that does not cause the spectral mask violation, wherein the packet is transmitted with the increased packet size.

21. A non-transitory computer-readable medium storing instructions executable by one or more processors to cause the one or more processors to:
determine one or more preamble symbols of a packet based on a mode of transmission of the packet, the one or more preamble symbols of the packet being associated with a receiver sensitivity limitation;
apply a power boost to the one or more preamble symbols by a power boost value, the power boost value being based on the mode of transmission of the packet;
determine whether the one or more preamble symbols with the applied power boost satisfy a spectral mask; and
transmit the packet when the one or more preamble symbols with the applied power boost satisfy the spectral mask.

22. The non-transitory computer-readable medium of claim 21, wherein the instructions executable by the one or more processors further cause the one or more processors to adjust a packet size of the packet to a next nearest valid packet size when the one or more preamble symbols with the applied power boost do not satisfy the spectral mask.

23. The non-transitory computer-readable medium of claim 21, wherein the instructions executable by the one or more processors further cause the one or more processors to:
determine that the one or more preamble symbols includes one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 transmit mode or a HE ER RU 242 with dual carrier modulation (DCM) transmit mode, and
increase a transmission power of each of the one or more L-SIG symbols, the one or more RL-SIG symbols and the one or more HE-SIGA symbols by the power boost value.

24. The non-transitory computer-readable medium of claim 21, wherein the instructions executable by the one or more processors further cause the one or more processors to:
determine that the one or more preamble symbols includes one or more L-STF symbols, one or more L-LTF symbols, one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 with dual carrier modulation (DCM) transmit mode, and
increase a first transmission power of each of the one or more L-STF symbols and the one or more L-LTF symbols by a first power boost value and further increase a second transmission power of each of the one or more L-SIG symbols, the one or more RL-SIG symbols and the one or more HE-SIGA symbols by a second power boost value greater than the first power boost value.

25. The non-transitory computer-readable medium of claim 21, wherein the instructions executable by the one or more processors further cause the one or more processors to:
determine input parameters comprising content of the one or more preamble symbols with the applied power boost,
determine whether the input parameters correspond to parameters in a valid set of parameters that do not cause a spectral mask violation, and
increase a packet size of the packet to a nearest valid packet size when the input parameters do not correspond to parameters in the valid set of parameters that do not cause the spectral mask violation.

26. An apparatus for wireless communication, comprising:
means for determining one or more preamble symbols of a packet based on a mode of transmission of the packet, the one or more preamble symbols of the packet being associated with a receiver sensitivity limitation;
means for applying a power boost to the one or more preamble symbols by a power boost value, the power boost value being based on the mode of transmission of the packet;
means for determining whether the one or more preamble symbols with the applied power boost satisfy a spectral mask; and
means for transmitting the packet when the one or more preamble symbols with the applied power boost satisfy the spectral mask.

27. The apparatus of claim 26, wherein the means for determining whether the one or more preamble symbols with the applied power boost satisfy the spectral mask is further configured to adjust a packet size of the packet to a next nearest valid packet size when the one or more preamble symbols with the applied power boost do not satisfy the spectral mask.

28. The apparatus of claim 26, wherein the means for determining the one or more preamble symbols of the packet is further configured to determine that the one or more preamble symbols includes one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 transmit mode or a HE ER RU 242 with dual carrier modulation (DCM) transmit mode, and wherein the means for determining whether the one or more preamble symbols with the applied power boost satisfy the spectral mask is further configured to increase a transmission power of each of the one or more L-SIG symbols, the one or more RL-SIG symbols and the one or more HE-SIGA symbols by the power boost value.

29. The apparatus of claim 26, wherein the means for determining the one or more preamble symbols of the packet is further configured to determine that the one or more preamble symbols includes one or more L-STF symbols, one or more L-LTF symbols, one or more L-SIG symbols, one or more repeat L-SIG (RL-SIG) symbols, and one or more high efficiency (HE) signal A (SIGA) symbols when the mode of transmission corresponds to a HE extended range (ER) resource unit (RU) 106 with dual carrier modulation (DCM) transmit mode, and wherein the means for determining whether the one or more preamble symbols with the applied power boost satisfy the spectral mask is further configured to increase a first transmission power of each of the one or more L-STF symbols and the one or more L-LTF symbols by a first power boost value and further increase a second transmission power of each of the one or more L-SIG symbols, the one or more RL-SIG symbols and the one or more HE-SIGA symbols by a second power boost value greater than the first power boost value.

30. The apparatus of claim 29, wherein the means for determining whether the one or more preamble symbols with the applied power boost satisfy the spectral mask is further configured to:
determine input parameters comprising content of the one or more preamble symbols with the applied power boost,
determine whether the input parameters correspond to parameters in a valid set of parameters that do not cause a spectral mask violation, and
increase a packet size of the packet to nearest valid packet size when the input parameters do not correspond to parameters in the valid set of parameters that do not cause the spectral mask violation.
